(19) United States
(12) Patent Application Publication
(10) Pub. No.: US 2007/0040943 A1
(43) Pub. Date: Feb. 22, 2007

(54) Digital noise reduction apparatus and method and video signal processing apparatus

(75) Inventor: Toshiyuki Namioka, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/504,082

(22) Filed: Aug. 15, 2006

(30) Foreign Application Priority Data
Aug. 19, 2005 (JP) 2005-239096

(51) Int. Cl. H04N 5/00

(52) U.S. Cl. 348/607

(57) ABSTRACT

According to one embodiment, a horizontal noise reduction circuit is supplied with an input video signal and the filter characteristic thereof is controlled by a noise reduction level setting value. A frame delay circuit delays the input video signal by a period of one frame. An inter-frame difference amount information counting circuit outputs a count value obtained by counting a preset logical value of a binary-coded output derived based on a difference between a frame delay video signal and the input video signal for one screen. A noise reduction level generator generates a noise reduction level setting value corresponding to the count value and supplies the same to the horizontal noise reduction circuit and vertical noise reduction circuit as a control signal.

### CROSS-REFERENCE TO RELATED APPLICATIONS

This application is based upon and claims the benefit of priority from Japanese Patent Application No. 2005-239096, filed Aug. 19, 2005, the entire contents of which are incorporated herein by reference.

### BACKGROUND

1. Field

One embodiment of the invention relates to a digital noise reduction apparatus and method and a video signal processing apparatus and is applied to, for example, a digital television receiver so as to permit the effect of the noise reduction operation to be adequately changed according to the noise level.

2. Description of the Related Art

As is well known in the art, recently, the technique for broadcasting TV programs in a digital form is advanced. For example, in Japan, not only satellite broadcasting such as BS (Broadcasting Satellite) digital broadcasting and 110-degree CS (Communication Satellite) digital broadcasting, but also terrestrial broadcasting is started.

In a television broadcast receiver, a desired packet is extracted from a transport stream and a video signal compressed in the packet is decoded. The video signal is compressed in an MPEG system.

When a signal compressed in the MPEG system is decoded, block noises, mosquito noises or the like may occur in some cases. Further, when a scene change is made, noises occurred after the scene change appear and drag on in the decoded signal for a while in some cases.

Conventionally, the technique for extracting a difference amount of pixels between frames or fields of the digital video signal to determine the moving picture or still picture and adaptively controlling the noise reduction level according to the determination result is provided (for example, Patent Document 1) (Jpn. Pat. Appln. KOKAI Publication No. 2002-10105). The control operation is performed to enhance the noise reduction level with respect to the picture which is extensively moved. On the other hand, the control operation is performed to lower the noise reduction level with respect to the picture which is less moved.

In the conventional technique, a difference amount of pixels between frames or fields is extracted, determination of the moving picture or still picture is made and the noise reduction level is controlled according to the determination result. In this case, as the moving picture determining factor, for example, the absolute values of difference amounts of pixels of one screen are accumulatively added and the moving picture is determined when the result of accumulative addition is larger than a threshold value.

However, with the above technique, there occurs a problem that identification information will be obtained without paying any attention to the size of the area of the moving picture (the size of the moving picture). For example, it is now supposed that the results of accumulative addition will be set to the same value A even in different conditions (in a case where the sizes of the moving pictures are different), for example.

It is now assumed that the results of accumulative addition are set to the same value A since the luminance difference between the fields or frames is large although the area of the moving picture is small. On the other hand, when the area of the moving picture is large and the luminance difference between the fields or frames is small, the results of accumulative addition are set to the same value A in some cases.

In the above cases (in cases where the areas of the moving picture are small and large), the noise reduction levels for one screen are set to the same value A. As a result, an unnecessary noise reduction process will also be performed for the region of the still picture on a screen on which the area of the moving picture is small.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of one embodiment.

FIGS. 2A and 2B are explanatory diagrams for illustrating the operation of an inter-frame difference amount information counting circuit 600 of FIG. 1.

FIG. 3 is an exemplary diagram showing the concrete configuration of a noise reduction level generation circuit 700 of FIG. 1.

FIG. 4 is an exemplary diagram showing the concrete configuration of a vertical noise reduction circuit 400 of FIG. 1.

FIG. 5 is diagram showing the operation flow of another embodiment.

FIG. 6 is a block diagram showing another embodiment.

FIG. 7 is an explanatory diagram showing an example of the configuration of a digital television receiver to which this invention is applied.

### DETAILED DESCRIPTION

Various embodiments according to the invention will be described hereinafter with reference to the accompanying drawings.

In one embodiment, a digital noise reduction apparatus and method and a video signal processing apparatus which can adequately acquire a noise reduction level are provided.

According to one aspect of the embodiment, a digital noise reduction apparatus includes a filter section which is supplied with an input video signal and whose filter characteristic is controlled by a noise reduction level setting value, a frame delay circuit which delays the input video signal by a period of one frame, an inter-frame difference amount information counting circuit which outputs a count value acquired by counting a preset logical value of a binary-coded output obtained based on a difference between a frame delay video signal from the frame delay circuit and the input video signal for one screen, and a noise reduction level generator which generates the noise reduction level setting value corresponding to the count value.

According to the above means, an adequate noise reduction level can be obtained since the inter-frame difference amount information counting circuit is provided.

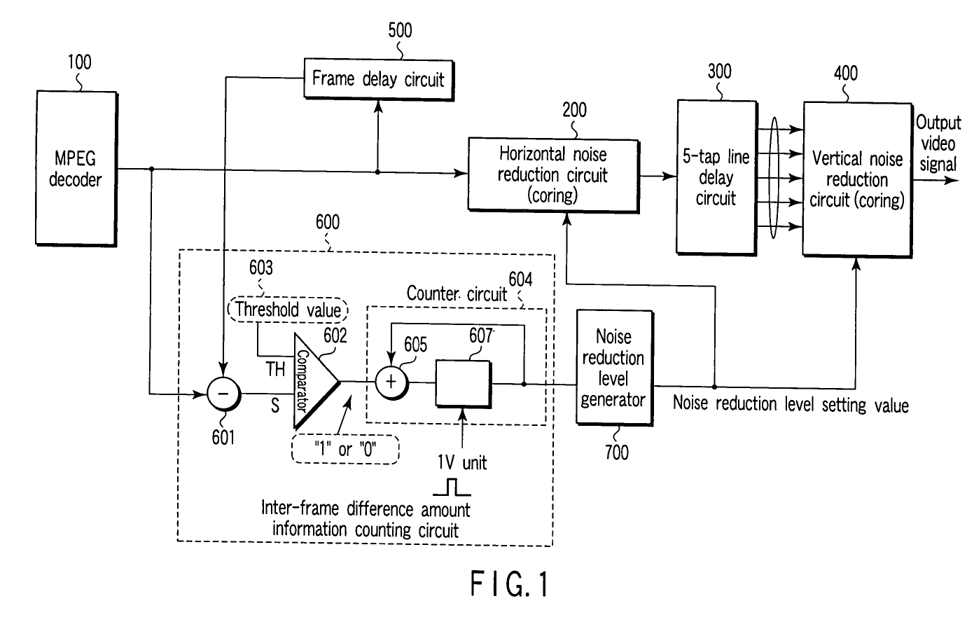

There will now be described embodiments of this invention with reference to the accompanying drawings. In FIG. 1, a reference symbol 100 denotes an MPEG decoder and a decoded output thereof is input to a horizontal noise reduction circuit 200, frame delay circuit 500 and inter-frame difference amount information counting circuit 600 as an input video signal.

The horizontal noise reduction circuit 200 is a filter using a clock delay element and coefficient unit, for example, and performs the reduction process for noises on the horizontal line in the horizontal direction. An output of the horizontal noise reduction circuit 200 is input to a 5-tap line delay circuit 300. The 5-tap line delay circuit 300 synchronizes the horizontal lines of five lines by use of a plurality of line delay circuits. The synchronized line signals are input to a vertical noise reduction circuit 400 in which the noise reduction process in the vertical direction is performed and the result is output to the output terminal.

In this case, a noise reduction level setting value which will be described later is supplied to the horizontal noise reduction circuit 200 and vertical noise reduction circuit 400 to control the noise reduction amounts thereof.

The inter-frame difference amount information counting circuit 600 has a subtracter 601. The subtracter 601 derives a difference value between the input video signal and the frame delay video signal. The difference value S is input to a comparator 602 and compared with a threshold value TH from a threshold value setting portion 603. The comparator 602 outputs “1” when |S|>TH and outputs “0” when |S|≦TH, for example.

An output of the comparator 603 is input to a counter circuit 604. The counter circuit 604 has an adder 605 and counter 607 and counts the number of inputs “1”. The counter circuit outputs a count value in the unit of one frame and supplies the count value to a noise reduction level generator 700.

The noise reduction level generator 700 outputs a noise reduction level setting value according to the count value of one frame. The noise reduction level setting value is supplied to the horizontal noise reduction circuit 200 and vertical noise reduction circuit 400 as control information used to control the noise reduction processing amount. For example, a limited value or coefficient value of the filter is controlled according to the noise reduction level setting value.

In the digital video compression process in the MPEG2 system, an encode process utilizing the correlation between the frames is performed. Therefore, when the count value is small, the correlation between the frames is high and so-called MPEG noise is less. However, when the count value is large, the MPEG noise tends to be increased. Therefore, the noise reduction level generator 700 outputs a noise reduction level setting value corresponding to the ratio of a portion in which the difference amount between the frames is large according to the count value of the counter circuit 604. The noise reduction level of the horizontal noise reduction circuit 200 is controlled according to the noise reduction level setting value to reduce noises by the coring process for the high-frequency components in the horizontal direction. Further, the noise reduction level of the vertical noise reduction circuit 400 is controlled according to the noise reduction level setting value to reduce noises by the coring process for the high-frequency components in the vertical direction.

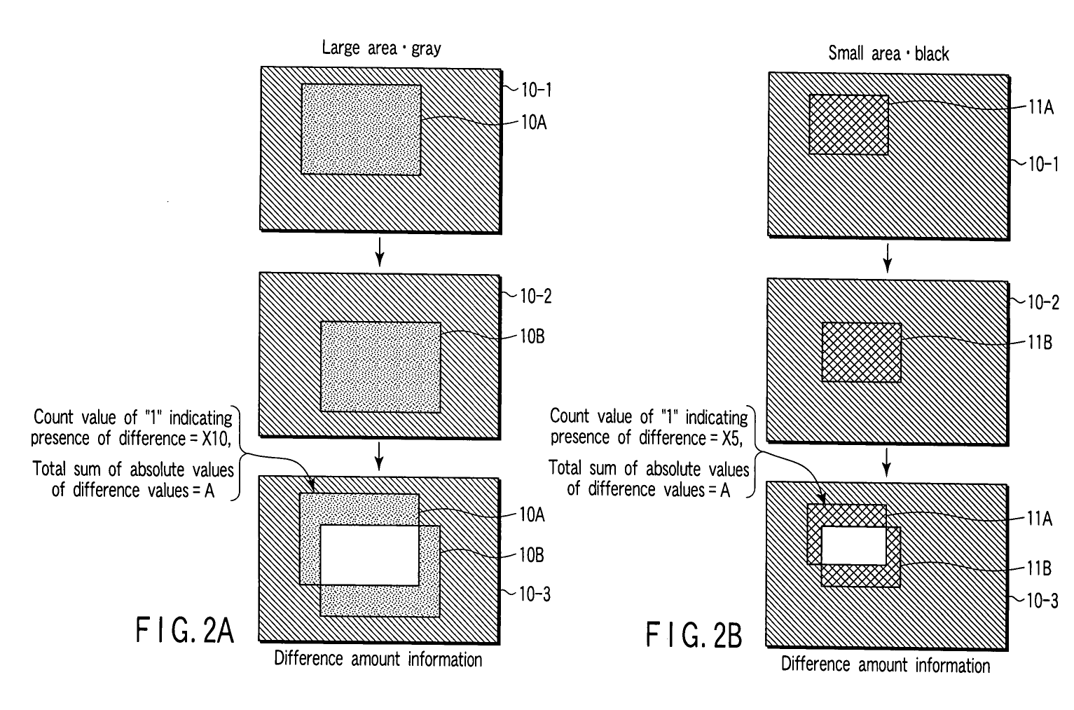

FIGS. 2A and 2B are diagrams for illustrating the function of the inter-frame difference amount information counting circuit 600.

A state in which a moving picture 10A is displayed on a screen 10-1 of FIG. 2A and the moving picture 10A is moved to a position of a moving picture 10B on a screen 10-2 is shown. On a screen 10-3, a state in which inter-frame difference amount information is acquired is shown.

A state in which a moving picture 11A is displayed on a screen 10-1 of FIG. 2B and the moving picture 11A is moved to a position of a moving picture 11B on a screen 10-2 is shown. On a screen 10-3, a state in which inter-frame difference amount information is acquired is shown.

The moving picture 10A of FIG. 2A is one example in which the area is large, the luminance level is gray, for example, and a difference thereof with respect to the luminance level of the background is small. On the other hand, the moving picture 11A of FIG. 2B is one example in which the area is small, the luminance level is black, for example, and a difference thereof with respect to the luminance level of the background is large.

The inter-frame difference amount information counting circuit 600 described before acquires a difference amount between the frames. For this purpose, a difference amount output of a white portion on the screen 10-3 is data “0” and a difference amount with respect to the background can be attained in a picture-deviated portion of the surrounding portion. The difference amount is a difference in the luminance level between the background and the moving picture at the output stage of the subtracter 601. Therefore, the difference in the luminance level is set larger in the case of FIG. 2B than in the case of FIG. 2A.

Thus, the following problem may occur if the absolute values of the outputs of the subtracter 601 are simply accumulatively added for one screen. It is now assumed that the accumulated addition result is set to the value A since the luminance difference between the fields or frames is large although the area of the moving picture is small in the example of FIG. 2B. On the other hand, when the area of the moving picture is large as shown in the example of FIG. 2A, the accumulated addition result is set to the same value A in some cases even if the luminance difference between the fields or frames is small.

In order to solve the above problem, the inter-frame difference amount information counting circuit 600 of FIG. 1 is configured to include the comparator 602 and the difference value is binary-coded. The binary-coded outputs of one screen are accumulatively added. When the above process is performed, a coefficient value of “1” indicating that a difference amount is present in the example of FIG. 2A and a coefficient value of “1” indicating that a difference amount is present in the example of FIG. 2B are set to different values without fail.

Therefore, determination of the moving picture or still picture can be prevented from being erroneously made. This is based on the fact that an adequate noise reduction level setting value is acquired.

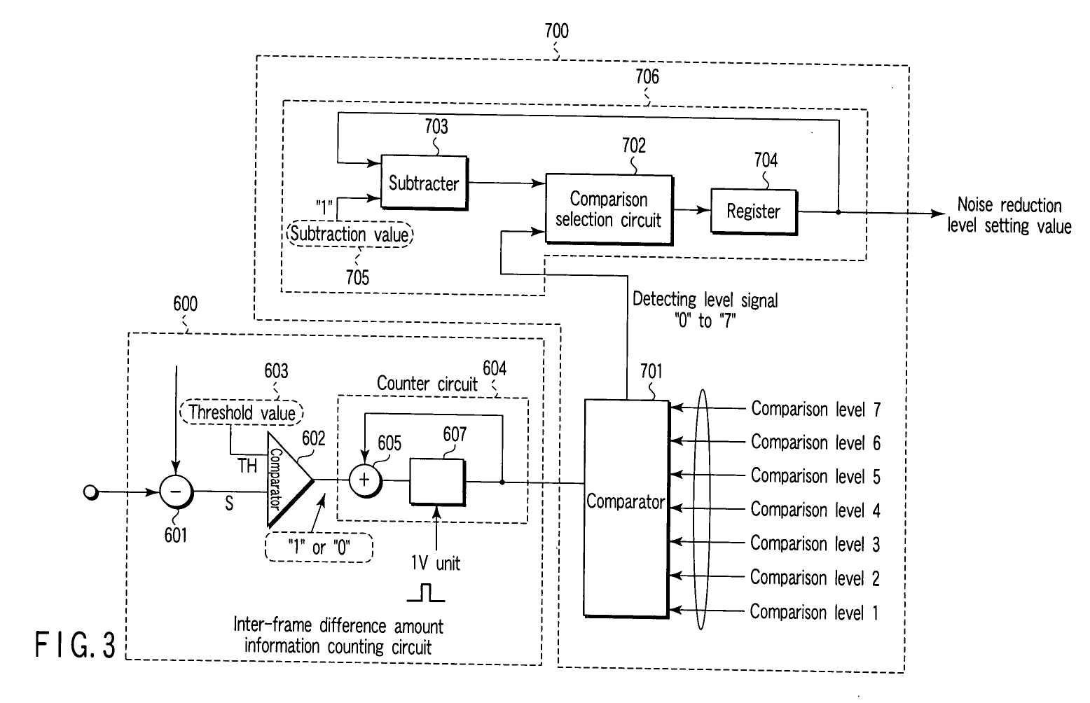

FIG. 3 specifically shows the detail configuration of the noise reduction level generator 700 which outputs a noise reduction level setting value according to the count value of the counter circuit 604. The output count value of the counter circuit 604 is input to a comparator 701. The comparator 701 prepares comparison values (level 1 to level 7) of eight steps. It outputs a detection level signal according to the count value and supplies the same to a comparison selection circuit 702. The detection level signal is obtained under the following determination.

Count value<Comparison level 1: Detection level signal=0

Comparison level 1≦Count value<Comparison level 2: Detection level signal=1

Comparison level 2≦Count value<Comparison level 3: Detection level signal=2

Comparison level 3≦Count value<Comparison level 4: Detection level signal=3

Comparison level 4≦Count value<Comparison level 5: Detection level signal=4

Comparison level 5≦Count value<Comparison level 6: Detection level signal=5

Comparison level 6≦Count value<Comparison level 7: Detection level signal=6

Comparison level 7≦Count value: Detection level signal=7

A subtracter 703 subtracts a subtraction value from a subtraction value setting section 705 from the noise reduction level setting value and supplies an output to the comparison selection circuit 702. The comparison selection circuit 702 compares an output of the subtracter 703 with a detection level signal output from the comparator 701 and selects and outputs a larger one of the compared signals. An output of the comparison selection circuit 702 is supplied to a register 704. The register 704 fetches an output of the comparison selection circuit 702 once for each screen period and holds the same until a process for a next screen is started. Data held in the register 704 is output as the noise reduction level setting value.

The subtraction value supplied from a subtraction value setting section 705 is one of integral numbers of “0” to “7”, for example, and it is now assumed that the subtraction value is set to “1” as an example. Now, the operation performed when a still picture such as a photograph is input as an input video signal and a scene change is made is explained.

When no difference is provided between the frames before the scene change, that is, when the input video signal is a still picture, a detection level signal from the comparator 701 is “0” and the noise reduction level setting value is also “0”. In a case where the video image contents are markedly changed due to the scene change, the difference amount between the frames becomes large and MPEG noise tends to increase. At this time, the detection level signal becomes large and is set to “7”, for example.

Then, when the still picture input state is set again after the scene change, the detection level signal is set to “0”. An output of the subtracter 703 is set to “6” obtained by subtracting “1” from “7” which is held in the register 704. In the next frame, an output (noise reduction level setting value) of the register 704 becomes “6”. After this, as long as the still picture is kept input, the subtraction process of the subtracter 703 is performed for each frame and an output (noise reduction level setting value) of the register 704 is sequentially set to “6”, “5”, “4”, “3”, “2”, “1”, “0”. Thus, the output tends to be sequentially reduced from the state in which much MPEG noises are present over several fields after the scene change. However, as described above, the noise reduction process can be adaptively performed by changing the noise reduction level from the high level to the low level.

As described above, the subtracter 703, comparison selection circuit 702 and register 704 are combined to configure a noise reduction level changing section 706. It outputs a detection level signal of a larger value directly as a noise reduction level setting value when the detection level signal changes from a small value to a large value. Further, it reduces the noise reduction level setting value in stages when the detection level signal changes from a large value to a small value.

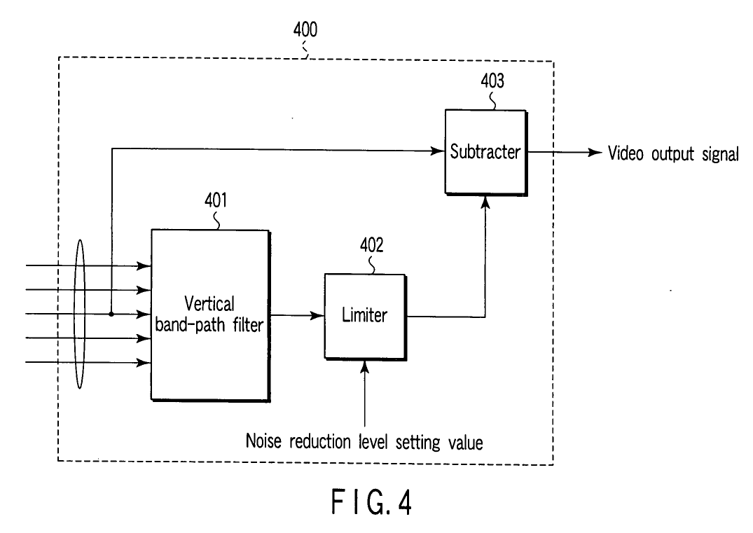

FIG. 4 shows an example of the concrete configuration of the vertical noise reduction circuit 400 shown in FIG. 1. A signal from the 5-tap line delay circuit 300 is input to a vertical band-pass filter 401. The vertical band-pass filter 401 performs the filtering process by use of the input signal and extracts a vertical high-frequency component containing noise components. The vertical high-frequency component is input to a limiter 402, subjected to amplitude limitation, for example, according to the noise reduction level setting value and then input to a subtracter 403. The subtracter 403 subtracts an output of the limiter 402 from a signal of the center tap of the line delay output signal and reduces the noise which is the vertical high-frequency component. As a result, a video signal having noises reduced by the high-frequency coring system can be obtained from the subtracter 403.

The amplitude of the output of the limiter 402 is set approximately equal to a noise reduction amount. Therefore, when it is assumed that a difference amount between the frames is large and a large amount of MPEG noises are generated, the noise reduction level setting value becomes large and the output of the limiter 402 is controlled to be changed to a larger value. Further, when the still pictures are successively provided, the noise reduction effect is lowered and deterioration of a signal in a detail portion of a picture which is lost together with the noise can be prevented.

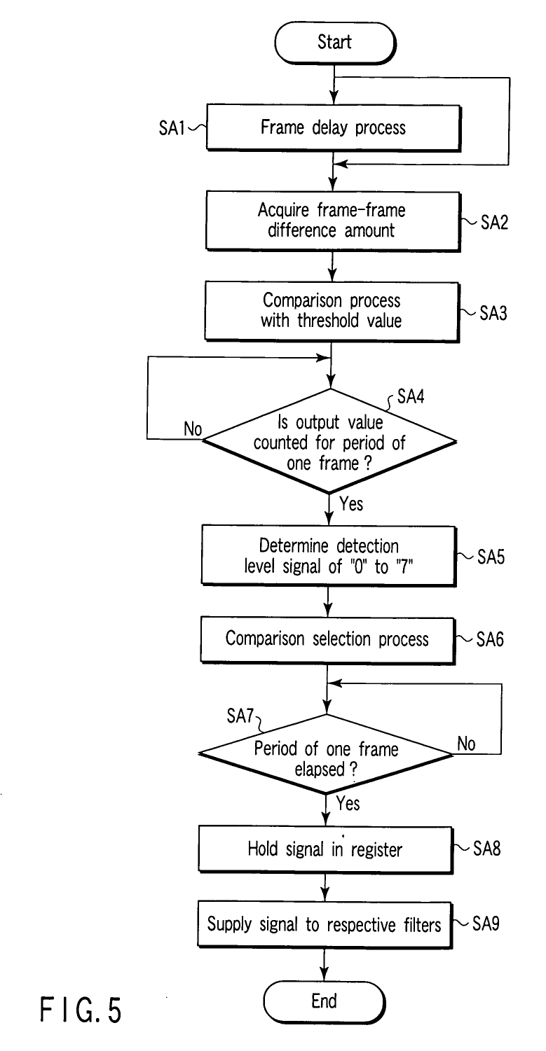

FIG. 5 is a flowchart for illustrating the operation of the apparatus of this invention.

An input video signal is subjected to a frame delay process (step SA1) and a difference amount between the frames of the video signal subjected to the frame delay process and the input video signal is derived (step SA2). Next, the difference amount is compared with a threshold value, “1” is output when the difference amount is larger than the threshold value, and “0” is output when the difference amount is smaller than the threshold value (step SA3).

The output value is counted for a period of one frame (step SA4) and a detection level signal of any one of the values “0” to “7” explained with reference to FIG. 3 is determined according to the count value (step SA5). The thus determined detection level signal is compared with a preset threshold value and a larger one of the compared values is selected (step SA6). Then, a signal selected each time the period of one frame has elapsed is held in the register (steps SA7, SA8). The holding signal of the register is supplied to each filter as a noise reduction level setting value (step SA9).

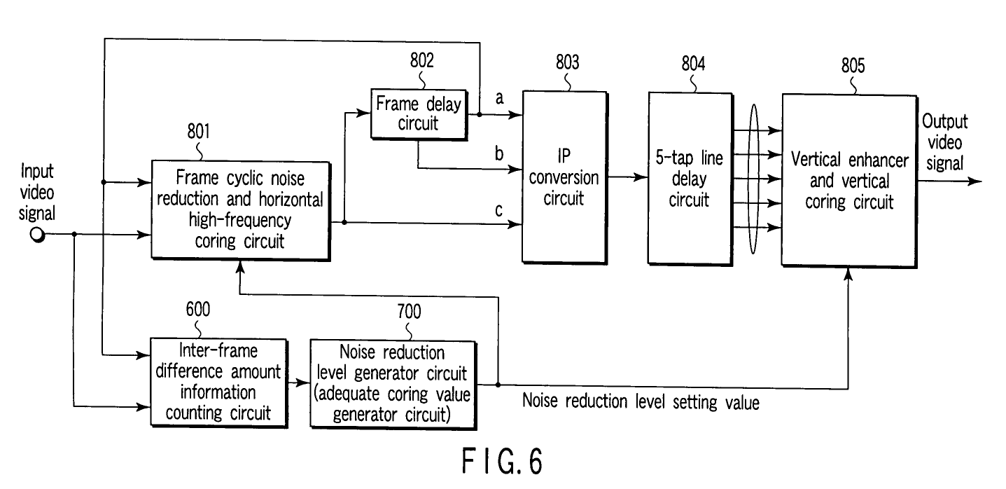

FIG. 6 shows an example in which the noise reduction apparatus according to this invention is incorporated into a system having an IP (Interlace-Progressive) conversion circuit, frame cyclic noise reduction circuit and vertical enhancer.

An input video signal from an input terminal 800 is input to a frame cyclic noise reduction and horizontal high-frequency coring circuit 801 and the inter-frame difference amount information counting circuit 600. The frame cyclic noise reduction and horizontal high-frequency coring circuit 801 performs a noise reduction process by the horizontal high-frequency coring system and a frame cyclic type noise reduction process by use of the input signal and a frame delay video signal from a frame delay circuit 802. An output of the frame cyclic noise reduction and horizontal high-frequency coring circuit 801 is input to the frame delay circuit 802 and IP conversion circuit 803. To the IP conversion circuit 803, a video signal “a” subjected to frame delay and a video signal “b” subjected to field delay from the frame delay circuit 802 and a present signal “c” are input. The IP conversion circuit 803 subjects the interlace signals to a spacing process, that is, an interpolation or interpolating process and generates and outputs a progressive signal. An output of the IP conversion circuit 803 is processed by a 5-tap line delay circuit 804 and signals of five horizontal lines are synchronized. The five horizontal line signals are input to a vertical enhancer and vertical coring circuit 805. The vertical enhancer and vertical coring circuit 805 performs a vertical enhancement process of adding a vertical high frequency component and vertical noise reduction process by coring according to the noise reduction level setting value. The noise reduction level setting value is also input to the frame cyclic noise reduction and horizontal high-frequency coring circuit 801 and the degree of the coring process can be controlled. The noise reduction level setting value is generated by the inter-frame difference amount information counting circuit 600 and noise reduction level generating circuit 700 as described before.

With the above configuration, the frame delay circuit (frame memory) 802 is used for the IP conversion process, frame cyclic noise reduction process and inter-frame difference amount information counting process. Therefore, by utilizing the frame delay circuit 802, it is not necessary to add a large-scale circuit to the existing circuit when the main portion of this invention is extended. Further, a line memory can be attained by using part of the vertical enhancer. Therefore, an increase in the circuit scale with respect to the existing system can be extremely suppressed and the apparatus of this invention can be incorporated at a low cost.

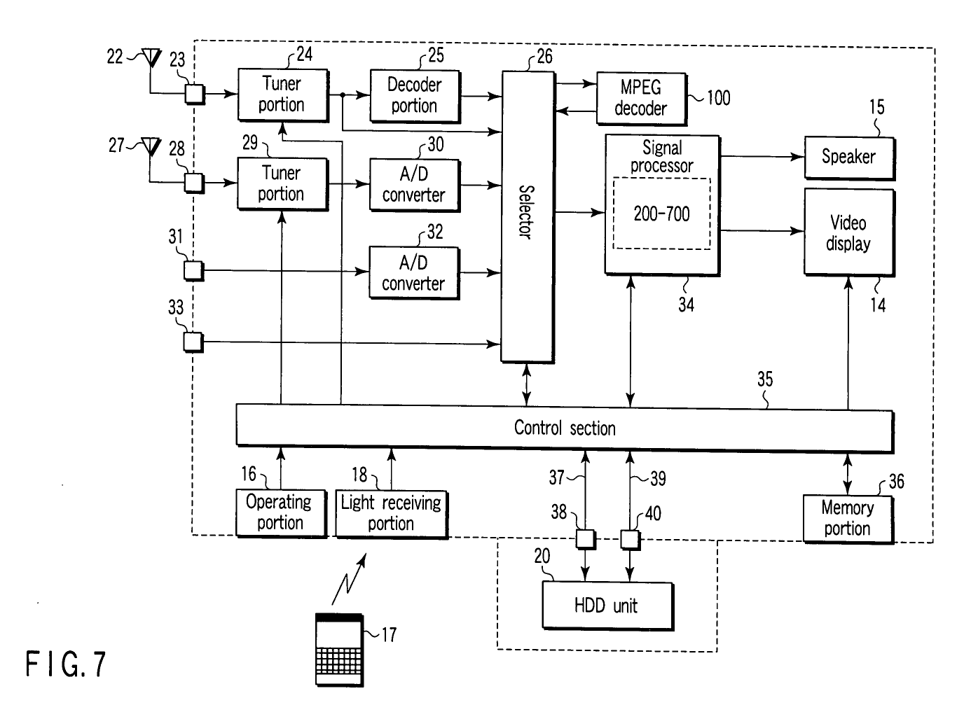

FIG. 7 schematically shows a signal processing system of a digital television broadcast receiver into which the noise reduction apparatus of this invention is incorporated.

The noise reduction apparatus is provided in a signal processing section 34. A digital television broadcast signal received by a digital television broadcast receiving antenna 22 is supplied to a tuner portion 24 via an input terminal 23. The tuner portion 24 selects and demodulates a signal of a desired channel from the input digital television broadcast signal. A signal output from the tuner potion 24 is supplied to a decoder portion 25 which in turn performs an MPEG (Moving Picture Experts Group) 2-decoding process in cooperation with an MPEG decoder 100, for example.

An output of the tuner portion 24 is directly supplied to a selector 26. Video and audio information items can be separated from the above signal and recorded in an HDD unit 20 via a control section 35.

An analog television broadcast signal received by an analog television broadcast signal receiving antenna 27 is supplied to a tuner portion 29 via an input terminal 28. The tuner portion 29 selects and demodulates a signal of a desired channel from the input analog television broadcast signal. After this, a signal output from the tuner portion 29 is converted into a digital form by an A/D (analog/digital) converter 30 and then output to the selector 26.

The analog video and audio signals supplied to an input terminal 31 for an analog signal are supplied to an A/D converter 32, converted into a digital form and output to the selector 26. The digital video and audio signals supplied to an input terminal 33 for a digital signal are supplied to the selector 26 as they are.

When the A/D-converted signal is recorded on the HDD unit 20, it is first subjected to the compression process into a preset format or by use of an MPEG (Moving Picture Experts Group) 2-system by an encoder attached to the selector 26 and then recorded on the HDD unit 20.

The selector 26 selects one of the four types of input digital video and audio signals and supplies the selected signal to the signal processor 34. The signal processor 34 subjects the input digital video signal to a preset signal process and causes the processed signal to be displayed on a video signal display 14. As the video signal display 14, for example, a flat-panel display such as a liquid crystal display and plasma display is used. Further, the signal processor 34 subjects the input digital audio signal to a preset signal process, outputs the signal converted into an analog form to a speaker 15 and performs the audio reproduction.

In this case, various operations containing various receiving operations of the television broadcast receiver 11 are generally controlled by the control section 35. The control section 35 is a microprocessor containing a CPU (Central Processing Unit) and the like, receives operation information transmitted from an operating portion 16 or operator 21 (not shown in FIG. 2) or operation information transmitted from a remote controller 17 via a light receiving portion 18 and controls the respective portions to reflect the operation contents on the operations of the respective portions.

In this case, the control section 35 uses a memory portion 36. The memory portion 36 mainly includes a ROM (Read Only Memory) which stores a control program executed by the CPU, a RAM which provides a work area for the CPU, and a nonvolatile memory in which various setting information items, control information items and the like are stored.

The control section 35 is connected to the HDD unit 20 contained in a stand 13. In this case, a line 37 which supplies power supply voltage and control signals from the control section 35 to the HDD unit 20 connects the control section 35 to the HDD unit 20 via a connecting portion 38.

Further, a line 39 which transfers digital video and audio signals between the control section 35 and the HDD unit 20 connects the control section 35 with the HDD unit 20 via an i.Link connecting portion 40. That is, transfer of the digital video and audio signals between the control section 35 and the HDD unit 20 is performed by use of the i.Link separately from transfer of the power supply voltage and control signal.

Then, the television broadcast receiver can record digital video and audio signals selected by the selector 26 on the HDD unit 20, reproduce the digital video and audio signals recorded on the HDD unit 20 and provide the signals for viewing and listening.

This invention is not limited to the above embodiments as it is and can be embodied by modifying the constituents without departing from the technical scope thereof at the embodying stage. Further, various inventions can be made by combining a plurality of constituents disclosed in the above embodiments. For example, several constituents can be eliminated from the whole constituents shown in the embodiments. Further, constituents over the different embodiments may be adequately combined.

While certain embodiments of the invention have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

What is claimed is:

1. A digital noise reduction apparatus comprising:
a filter section which is supplied with an input video signal and whose filter characteristic is controlled by a noise reduction level setting value,
a frame delay circuit which delays the input video signal by a period of one frame,
an inter-frame difference amount information counting circuit which outputs a count value obtained by counting a preset logical value of a binary-coded output derived based on a difference between a frame delay video signal from the frame delay circuit and the input video signal for one screen, and
a noise reduction level generator which generates the noise reduction level setting value corresponding to the count value.

2. The digital noise reduction apparatus according to claim 1, wherein the inter-frame difference amount information counting circuit includes a subtracter which derives a difference output between an output video signal of the frame delay circuit and the input video signal, a comparator which compares the difference output with a threshold value and derives the binary-coded output, and a counter circuit which counts the preset logical value of the binary-coded output for a period of one frame and derives the count value.

3. The digital noise reduction apparatus according to claim 1, wherein the filter section includes a horizontal noise reduction circuit and a vertical noise reduction circuit.

4. The digital noise reduction apparatus according to claim 1, wherein a signal from the frame delay circuit which outputs a signal used in an interlace progressive convention circuit is used as the frame delay video signal.

5. The digital noise reduction apparatus according to claim 1, wherein the filter section includes a vertical enhancer and vertical coring circuit.

6. A digital noise reduction apparatus comprising:
a filter section which is supplied with an input video signal and whose filter characteristic is variably set by a noise reduction level setting value,
a frame delay circuit which delays the input video signal by a period of one frame,
an inter-frame difference amount information counting circuit which outputs a count value obtained by counting a preset logical value of a binary-coded output derived based on a difference between a frame delay video signal from the frame delay circuit and the input video signal for one screen,
a comparator which compares the count value with a plurality of comparison levels having different values and outputs a comparison level corresponding to the count value as a detection level signal, and
a noise reduction level varying section which selects and outputs a detection level signal of a larger value as the noise reduction level setting value when the value of the detection level signal varies from a small value to a large value and reduces the noise reduction level setting value in stages when the value of the detection level signal varies from a large value to a small value.

7. The digital noise reduction apparatus according to claim 6, wherein the noise reduction level varying section includes a subtracter which derives a difference between a preset subtraction value and the noise reduction level setting value, a comparison selection circuit which compares the difference with the detection level signal and selects and outputs a larger one of the compared signals, and a register which outputs an output of the comparison selection circuit as the noise reduction level setting value.

8. The digital noise reduction apparatus according to claim 6, further comprising a television receiver which receives the input video signal.

9. The digital noise reduction apparatus according to claim 8, further comprising an MPEG decoder which decodes the input video signal to derive a decoded video signal.

10. A digital noise reducing method used in a digital noise reduction apparatus including a filter section which filters an input video signal, a frame delay circuit, an inter-frame difference amount information counting circuit and a noise reduction level generator and supplying a noise reduction level setting value to the filter section, comprising:
delaying the input video signal by a period of one frame by the frame delay circuit and outputting a frame delay video signal,
counting a preset logical value of a binary-coded output derived based on a difference between the frame delay video signal and the input video signal by use of the inter-frame difference amount information counting circuit for one screen and outputting a count value, and
generating the noise reduction level setting value corresponding to the count value by use of the noise reduction level generator.

11. The digital noise reducing method according to claim 10, wherein the inter-frame difference amount information counting circuit includes a subtracter, comparator and counter circuit, the subtracter generates a difference between the frame delay video signal and the input video signal, the comparator compares the difference with a threshold value and generates the binary-coded output, and the counter circuit counts a preset logical value of the binary-coded output for a period of one frame and outputs the count value.

12. The digital noise reducing method according to claim 10, wherein the noise reduction level generator includes a comparator and noise reduction level varying section, the comparator compares the count value with a plurality of comparison levels having different values and outputs a comparison level corresponding to the output value as a detection level signal, and the noise reduction level varying section directly outputs a detection level signal of a larger value as the noise reduction level setting value when the value of the detection level signal varies from a small value to a large value and reduces the noise reduction level setting value in stages when the value of the detection level signal varies from a large value to a small value.
